(19) United States
(12) Patent Application Publication
(10) Pub. No.: US 2019/0334808 A1
(43) Pub. Date: Oct. 31, 2019

(54) DATA PLANE FORWARDING TABLE DOWNED LINK UPDATING

(71) Applicant: Hewlett Packard Enterprise Development LP, Houston, TX (US)

(72) Inventors: Tathagata Nandy, Bengalura (IN); Keshava A, Bangalore (IN); Madhusoodhana Chari S, Bangalore (IN)

(21) Appl. No.: 15/965,871

(22) Filed: Apr. 28, 2018

(51) Int. Cl. H04L 12/755; H04L 12/703; H04L 12/24; H04L 12/741

(52) U.S. Cl. CPC H04L 45/021; H04L 45/28; H04L 45/22; H04L 45/74; H04L 41/12

(57) ABSTRACT

A centralized database network routing system for a network may include a data plane comprising a forwarding table and link failover logic to identify a downed link in a transmission path of the network and a control plane for the data plane. The control plane may include a centralized database routing table and updating logic to update the forwarding table based upon the identified downed link independent of updating of the centralized database routing table.

### BACKGROUND

Network switches are used to process and forward data in a network. Network switches may include a data plane. The data plane, also referred to as a forwarding plane, refers to all the functions and processes of the switch that forward packets/frames from one interface of the network switch to another. The data plane forwards traffic to the next hop along the path to a selected destination according to control plane logic.

Control plane logic is provided by a control plane. Some network switches may include the control plane. In other networks, such as software defined networks (SDN's), a centralized controller may provide the control plane for the switch. The control plane refers all functions and processes that determine which path should be used to transmit the data. Control plane functions include system configuration, management and exchange of routing table information. The control plane exchanges topology information with other switches and constructs a routing table based on a routing protocol. The routing table may reflect those links in the network that are no longer working or are downed. The routing table is used by the control plane to control the data plane.

### BRIEF DESCRIPTION OF THE DRAWINGS

FIG. 1 is a block diagram schematically illustrating portions of an example centralized database network routing system.

FIG. 2 is a flow diagram of an example method for updating a forwarding table of a downed link in a centralized database network routing system.

FIG. 3 is a block diagram schematically illustrating portions of an example centralized database network routing system.

FIG. 4 is a block diagram schematically illustrating portions of an example centralized database network routing system.

FIG. 5 is a block diagram schematically illustrating portions of an example network switch for use as part of an example centralized database network routing system.

FIG. 6 is a flow diagram of an example method for updating a forwarding table of the network switch of FIG. 5.

FIG. 7 is a block diagram schematically illustrating portions of an example network switch for use as part of an example centralized database network routing system.

FIG. 8 is a flow diagram of an example method for updating a forwarding table of the network switch of FIG. 7.

FIG. 9 is a block diagram schematically illustrating portions of an example network switch for use as part of an example centralized database network routing system.

FIG. 10 is a flow diagram of an example method for updating the forwarding table of the network switch of FIG. 9.

FIG. 11 is a block diagram schematically illustrating portions of an example network switch for use as part of an example centralized database network routing system.

FIG. 12 is a flow diagram of an example method for updating the forwarding table of the network switch of FIG. 11.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example network routing systems and methods that utilize a centralized database routing table and that facilitate more timely route convergence. Route convergence refers to the time for a set of routers or network switches to reach agreement on a network topology, the current state of the various switches and links in the network. Disclosed herein are example centralized database network routing systems and methods that may more quickly adapt to a downed network link. The disclosed example centralized database network routing systems and methods facilitate updating of layer 3 data plane forwarding tables with downed link information independent of the updating of the control plane centralized database routing table. As a result, the layer 3 data plane forwarding table is not delayed by the updating of the control plane centralized database routing table, enhancing data transmission performance.

Disclosed herein is an example centralized database network routing system for a network. The centralized database network routing system for the network may include a data plane comprising a forwarding table and link failover logic to identify a downed link in a transmission path of the network and a control plane for the data plane. The control plane may include a centralized database routing table and updating logic to update the forwarding table based upon the identified downed link independent of updating of the centralized database routing table.

Disclosed herein is an example network switch that may include at least one port connected to a network, at least one processing unit and at least one memory. The at least one memory may include an integrated circuit providing a data plane for the network switch and instructions providing a control plane for the data plane. The data plane may include a forwarding table and link failover logic to identify a downed link in a transmission path of the network. The control plane may include a centralized database routing table and updating logic to update the forwarding table based upon the identified downed link prior to updating of the centralized database routing table.

Disclosed herein is an example method for updating the occurrence or identification of a downed link in a data plane forwarding table. The method may include identifying a downed link in a transmission path of a network, updating a centralized database routing table of a control plane of a network switch based upon the identified downed link and updating a forwarding table of a data plane of the network switch based upon the identified downed link independent of the updating of the centralized database routing table based upon the identified downed link.

Disclosed herein is an example non-transitory computer-readable medium for carrying out updating the occurrence or identification of a downed link in a data plane forwarding table. The medium may include instructions to direct a processing unit to identify a downed link in a transmission path of a network, update a centralized database routing table of a control plane of a network switch based upon the identified downed link and update a forwarding table of a data plane of the network switch based upon the identified downed link independent of the updating of the centralized database routing table based upon the identified downed link.

In some implementations, the disclosed network switches have a centralized database architecture and operate according to a centralized database architecture protocol. One example of such a centralized database architecture protocol is an open vswitch database (OVSDB) architecture or protocol. In some implementations, the disclosed switches operate in accordance with an equal-cost multi-path (ECMP) routing protocol or strategy.

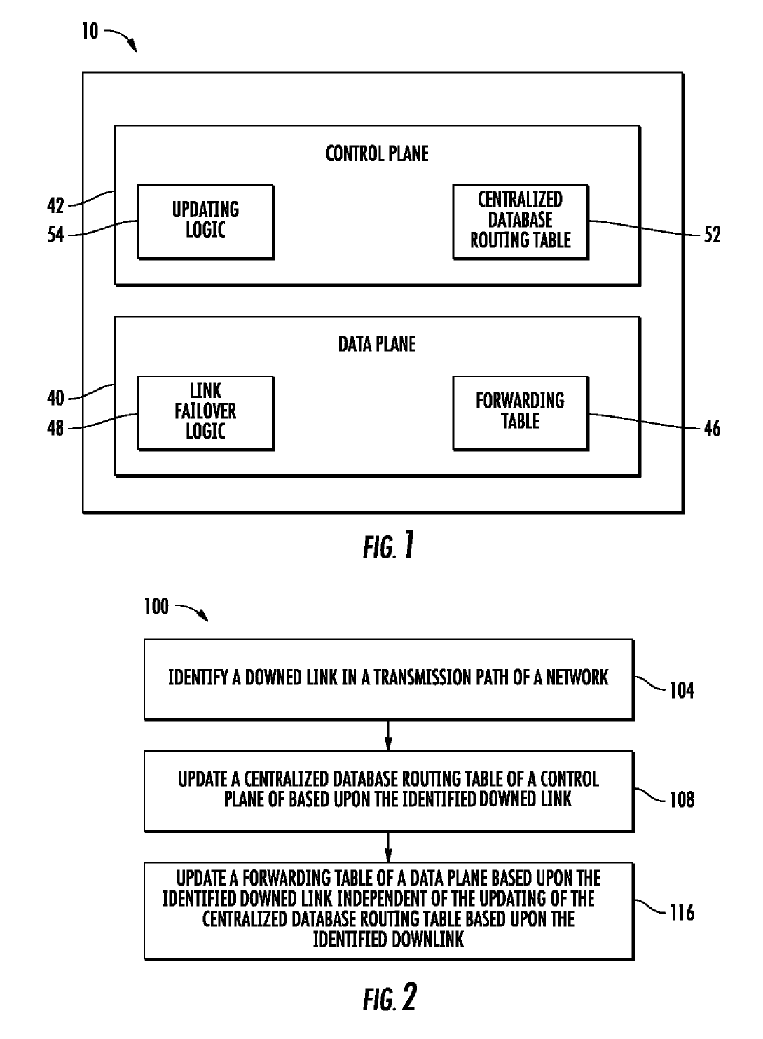

FIG. 1 is a schematic block diagram of portions of an example centralized database network routing system 10. System 10 routes network traffic, sometimes referred to as packets or frames, using network switches. Each network switch includes the data plane 40. Data plane 40 carries out functions pertaining to the forwarding of packets/frames from one interface of the network switch to another. In one implementation, data plane 40 is the form of an application-specific integrated circuit. The data plane forwards traffic in accordance with a forwarding table 46 to the next hop along the path to a selected destination. The forwarding table 46 is populated are generated by control plane 42 in accordance with routing protocols and based upon a centralized database routing table 52.

Control plane 42 maintains a centralized database routing table 52 utilizes a centralized database routing table 52 and stored routing protocols to program and control the operation of data plane 40. In one implementation, control plane 42 comprises a non-transitory computer-readable medium containing instructions for directing and associated processing unit to program or control the operation of data plane 40. In one implementation, control plane 42 is provided as part of a central network controller (such as a software defined network (SDN) controller, while data plane 40 is provided by each of the individual switches under control of controller. In another implementation, each of the network switches includes both data plane 40 and control plane 42.

As further shown by FIG. 1, data plane 40 comprises link failover logic 48 while control plane 42 comprises updating logic 54. Link failover logic 48 comprises logic, in the form of software, integrated circuitry or other instructions, that direct an associated processor in the detection of a failed link. In one implementation, link failover logic 48 may comprise logic in layer 3 of the data plane, wherein a failed link is identified by completion of a timeout, wherein a layer 3 timeout refers to a lack of a response from a destination across a link during a predefined amount of time. In another implementation, link failover logic 48 may comprise logic in a layer 2 of the data plane, the layer of the data plane that handles aspects pertaining to media access control (MAC) addresses. In such an implementation, a failed link may be determined based upon completion of a timeout at layer 2, wherein a layer 2 timeout refers to a lack of response to the layer 2 of the data plane from a destination across a link during a predefined amount of time. In yet another implementation, the link failover logic 48 may comprise logic provided in a layer 1 of the data plane, the layer one of the data plane controlling physical aspects of the network switch. In one implementation, the link failover logic 48 may comprise an intra-band fault detection module that detects link failures in response to receiving signals from downstream hardware indicating a failed link or in response to polling of the downstream link. In one implementation, the intraband fault detection module serving as the link failover logic may comprise a link scan module.

Updating logic 54 comprises programming or instructions that direct and associated processing unit to automatically update forwarding table 46 of data plane 40 in response to being notified by link failover logic 48 that a link has gone down or has failed. In one implementation, the updating logic is in the same layer of the control plane as the layer of the data plane 40 containing the link failover logic. For example, in implementations where the failover logic is in layer one of data plane 40, the updating logic may be in layer 1 of control plane 42. In implementations where the failover logic is in layer 2 of data plane 40, the updating logic may be in layer 2 of control plane 42. In implementations where the failover logic is in layer 3 of data plane 40, the updating logic may be in layer 3 of control plane 42.

In each of such instances, the updating logic may direct layer 3 of the data plane 40 to carry out the updating of forwarding table 26 which is located in layer 3 of data plane 40. For example, in implementations where the updating logic is in layer 3 of control plane 42, the updating logic would instruct layer 3 of data plane 40 two update forwarding table 46. In implementations where the updating logic is in layer 2 of control plane 42, the updating logic would would instruct layer 3 of data plane 42 update forwarding table 46. In implementations where the updating logic is in layer 1 of control plane 42, the updating logic would instruct layer 3 of data plane 40 to update forwarding table 46.

In each of the above instances, upon receiving notification of a downed link from the link failover logic 48, the updating logic 42 may further initiate updating of the centralized database routing table 52 based upon the identified downed link. However, the initiation of updating of the centralized database routing table 52 is independent of the directed updating of forwarding table 26. As a result, forwarding table 46 may be updated in a more timely fashion, not having to wait for updating of centralized database routing table 52. The more timely updating of forwarding table 46 with an identified downed link facilitates more immediate or faster adaptation to the downed link and transmission of data packets by switch 20.

FIG. 2 is a flow diagram of an example method 100 for updating the occurrence or identification of a downed link in a data plane forwarding table. Method 100 facilitates updating of layer 3 data plane forwarding tables with downed link information independent of the updating of the control plane centralized database routing table. As a result, the layer 3 data plane forwarding table is not delayed by the updating of the control plane centralized database routing table, enhancing data transmission performance. Although method 100 described with respect to system 20, it should be appreciative method 100 may be carried out with any of the following disclosed systems or switches.

As indicated by block 104, link failover logic 48 identifies a downed link in a transmission path of network 20. In particular, link failover logic 48 identifies those links or next hops from a switch which are down. In one implementation, such failed links may be identified by an intraband fault detection module, such as a link scan module, provided in a layer 1 (responsible or physical aspects of the switch) of data plane 40. In another implementation, such failed links may be identified by a timeout experienced by layer 2 (responsible for MAC addresses) of data plane 40. In yet another implementation, such failed link may be identified by timeout experienced by layer 3 (responsible for IP addresses) of data plane 40. In such implementations, the link failover logic 48 causes the corresponding layer of the control plane 42 to be notified of the link failure.

As indicated by block 108, the layer of the control plane receiving the notification of the downed link directs processor 26 to update the centralized database routing table 52 based upon the identified downed link.

As indicated by block 116, the layer of the control plane receiving the notification of the downed link further direct processor 26 to update forwarding table 46 of data plane 40 based on the identified downed link. Such updating of the forwarding table is independent of the updating of the centralized database routing table based upon the identified link. In one implementation, such updating of the forwarding table is initiated concurrently or prior to initiation of the updating of the centralized database routing table based upon the identified downed link. In one implementation,

The method may include identifying a downed link in a transmission path of a network, updating a centralized database routing table of a control plane of a network switch based upon the identified downed link and updating a forwarding table of a data plane of the network switch based upon the identified downed link independent of the updating of the centralized database routing table based upon the identified downed link. The layer of the control plane receiving the notification of the downed link directs processor 26 to cause layer 3 of data plane 40 to update the forwarding table 46 based upon the downed link. In one implementation, the entry in forwarding table 46 for the downed link is removed or changed to a null value. Because the initiation of updating of the centralized database routing table 52 is independent of the directed updating of forwarding table 26, forwarding table 46 may be update in a more timely fashion, not having to wait for updating of centralized database routing table 52. The more timely updating of forwarding table 46 with an identified downed link facilitates more immediate or faster adaptation to the downed link and transmission of data packets by switch 20.

FIG. 3 schematically illustrates portions of an example centralized database network routing system 210. Routing system 210 utilizes a software defined network (SDN) control scheme comprising network elements or switches 220 under the control of a controller 221. Each of switches 220 comprise a port 222 and data plane 40 (described above). Controller 221 comprises control plane 42 (described above). As described above with respect to system 20, in response to receiving notification from link failover logic 48 of a particular switch 220, updating logic 54 of control plane 42 automatically updates forwarding table 46 of the particular switch based upon the downed link and independent of any updating of the centralized database routing table 52. Because the initiation of updating of the centralized database routing table 52 is independent of the directed updating of forwarding table 26, forwarding table 46 may be updated in a more timely fashion, not having to wait for updating of centralized database routing table 52. The more timely updating of forwarding table 46 with an identified downed link facilitates more immediate or faster adaptation to the downed link and transmission of data packets by the particular switch 220.

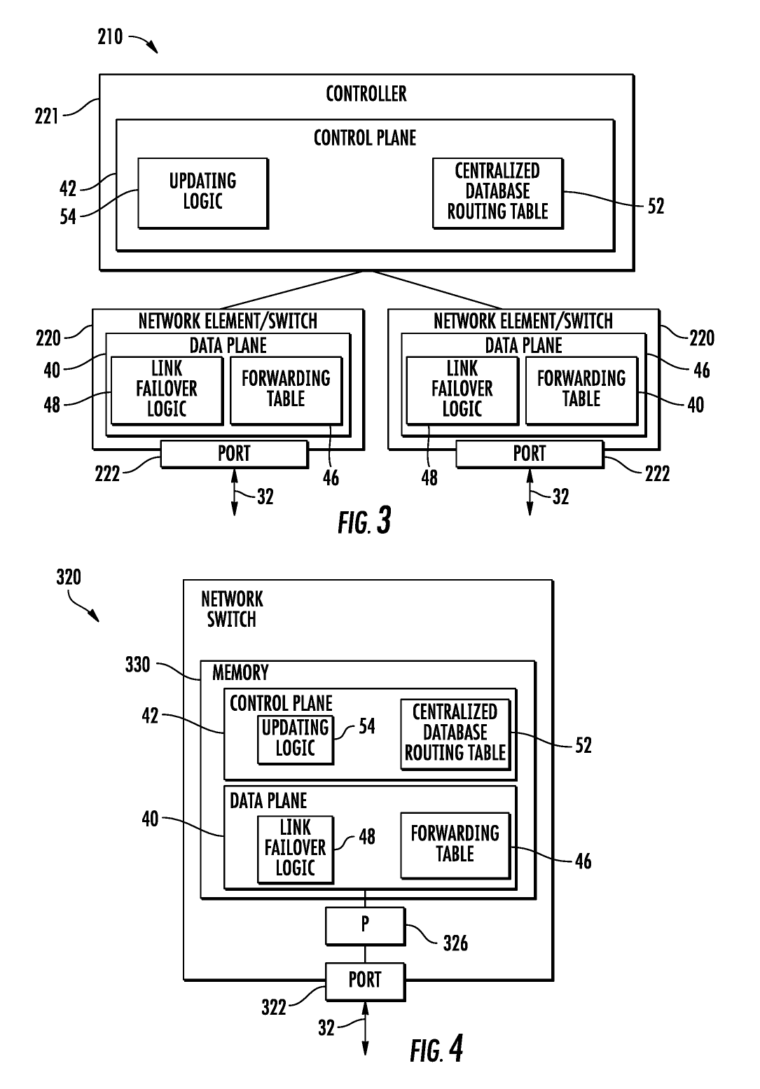

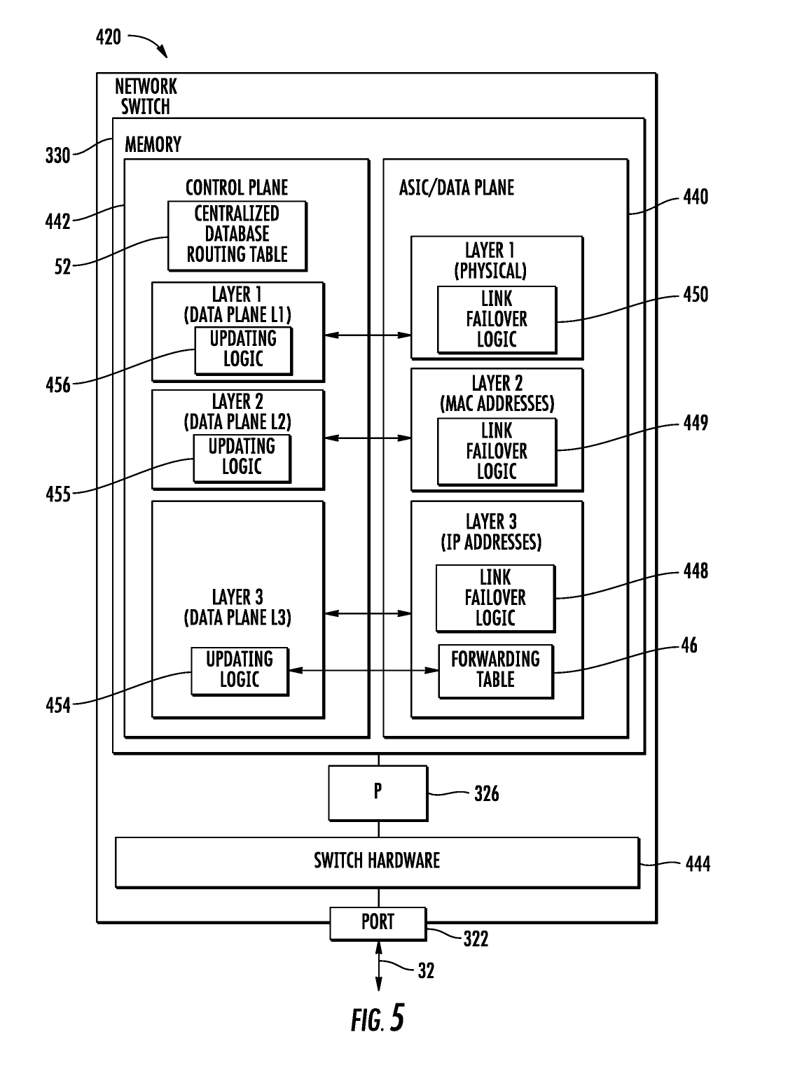

FIG. 4 schematically illustrates portions of an example network switch 320. Network 320 is similar to network switch 220 described above of the network switch 320 incorporates both data plane 40 and control plane 42. Network switch 320 may more quickly adapt to a downed network link. In one implementation, network switch 420 may facilitate updating of layer 3 data plane forwarding tables with downed link information independent of the updating of the control plane centralized database routing table. As a result, the layer 3 data plane forwarding table is not delayed by the updating of the control plane centralized database routing table, enhancing data transmission performance. Network switch 420 comprises port 322, at least one processing unit 326 and at least one memory 330.

Port 322 maybe one of many ports provide a network switch 320. Port 322 facilitates connection to a network via a link 32 (shown in broken lines). Port 322 receives and transmits data, such as in the form of packets or frames.

The at least one processing unit 326 follows instructions contained in memory 330. Processing unit 326 controls the routing of data in accordance with the instructions contained in memory 330.

The at least one memory 330 comprises a non-transitory computer-readable medium, in the form of software and/or application-specific integrated circuitry, that provides instructions for controlling processing unit 326. The at least one memory 330 comprises data plane 40 and control plane 42. Data plane 40 serves control plane 42. Data plane 40 is programmed or controlled by control plane 42. Data plane 40, also referred to as a forwarding plane, carries out functions and processes of the switch 22 forward packets/frames from one interface of the network switch 20 to the next hop along link 32.

As shown by FIG. 1, data plane 40 comprises forwarding table 46 and link failover logic 48. Forwarding table 46 comprise a table in memory 30 which stores address information regarding the links from network switch 20. Forwarding table 46 may be provided as part of a layer 3 of the data plane, the layer that handles aspects pertaining to Internet protocol (IP) addresses. Forwarding table 46 may be initially populated or programmed by a corresponding layer 3 of control plane 42.

Link failover logic 48 comprises logic, in the form of software, integrated circuitry or other instructions, that direct processor 26 in the detection of a failed link. In one implementation, link failover logic 48 may comprise logic in layer 3 of the data plane, wherein a failed link is identified by completion of a timeout, wherein a layer 3 timeout refers to a lack of a response from a destination across a link during a predefined amount of time. In another implementation, link failover logic 48 may comprise logic in a layer 2 of the data plane, the layer of the data plane that handles aspects pertaining to media access control (MAC) addresses. In such an implementation, a failed link may be determined based upon completion of a timeout at layer 2, wherein a layer 2 timeout refers to a lack of response to the layer 2 of the data plane from a destination across a link during a predefined amount of time. In yet another implementation, the link failover logic 48 may comprise logic provided in a layer 1 of the data plane, the layer one of the data plane controlling physical aspects of the network switch. In one implementation, the link failover logic 48 may comprise an intra-band fault detection module that detects link failures in response to receiving signals from downstream hardware indicating a failed link or in response to polling of the downstream link. In one implementation, the intraband fault detection module serving as the link failover logic may comprise a link scan module.

Control plane 42 comprises that portion of memory 30 dedicated to determining which path should be used to transmit the data. Control plane functions include system configuration, management and exchange of routing table information. Control plane 42 exchanges topology information with other switches and constructs the centralized database routing table 52 based on a routing protocol. Control plane 42 programs or controls data plane 40. In implementations where data plane 40 comprises layer 1, layer 2 and layer 3 as described above, control plane 42 comprises layer 1, layer 2 and layer 3 for programming and controlling layer 1, layer 2 and layer 3 of the data plane, respectively.

Control plane 42 comprises centralized database routing table 52 and updating logic 54. Routing table 52 is populated and maintained by control plane 42 based upon routing protocol settings. The routing table 52 may reflect those links in the network that are no longer working or are “downed”. The routing table 52 is used by the control plane 42 to control the data plane 40.

Updating logic 54 comprises programming or instructions that direct the at least one processing unit 26 to automatically update forwarding table 26 of data plane 40 in response to being notified by link failover logic 48 that a link has gone down or has failed. In one implementation, the updating logic is in the same layer of the control plane as the layer of the data plane 40 containing the link failover logic. For example, in implementations where the failover logic is in layer one of data plane 40, the updating logic may be in layer 1 of control plane 42. In implementations where the failover logic is in layer 2 of data plane 40, the updating logic may be in layer 2 of control plane 42. In implementations where the failover logic is in layer 3 of data plane 40, the updating logic may be in layer 3 of control plane 42.

In each of such instances, the updating logic may direct layer 3 of the data plane 40 to carry out the updating of forwarding table 26 which is located in layer 3 of data plane 40. For example, in implementations where the updating logic is in layer 3 of control plane 42, the updating logic would instruct layer 3 of data plane 40 two update forwarding table 46. In implementations where the updating logic is in layer 2 of control plane 42, the updating logic would would instruct layer 3 of data plane 42 update forwarding table 46. In implementations where the updating logic is in layer 1 of control plane 42, the updating logic would instruct layer 3 of data plane 40 to update forwarding table 46.

In each of the above instances, upon receiving notification of a downed link from the link failover logic 48, the updating logic 42 may further initiate updating of the centralized database routing table 52 based upon the identified downed link. However, the initiation of updating of the centralized database routing table 52 is independent of the directed updating of forwarding table 26. As a result, forwarding table 46 may be updated in a more timely fashion, not having to wait for updating of centralized database routing table 52. The more timely updating of forwarding table 46 with an identified downed link facilitates more immediate or faster adaptation to the downed link and transmission of data packets by switch 320.

FIG. 5 schematically illustrates portions of an example network switch 420. Network switch 420 is similar to network switch 320 described above except that network switch 420 is specifically illustrated as comprising data plane 440, control plane 442 and switch hardware 444. The remaining components of network switch 420 which correspond with the network switch 320 are numbered similarly.

Data plane 440 is similar to data plane 40 described above except that data plane 440 is specifically illustrated as comprising layer 1, layer 2 and layer 3. Layer 1, layer 2 and layer 3 correspond to layer 1, layer 2 and layer 3, respectively, of the TCP/IP model. Layer 1 of data plane 440 corresponds to layer 1 of the TCP/IP/model in that layer 1 is the physical layer, concerned with the transmission and reception of unstructured raw bit stream over a physical media such as data encoding, physical medium attachment, transmission techniques, and the like. Layer 2 of data plane 440 corresponds to the data link layer or layer 2 of the TCP/IP model in that layer 2 provides transfer of data frames from one node to another over the physical layer. For example, layer 2 establishes and terminates logical links between nodes, frame traffic control, frame sequencing, frame acknowledgment, frame delimiting, frame error checking and media access control (MAC) addresses. Layer 3 corresponds to the network layer 3 of the TCP/IP model in that layer 3 control the operation of the subnet, deciding which physical path the data takes. Layer 3 handles routing, subnet traffic control, frame fragmentation, logical-physical address mapping and subnet usage accounting. Layer 3 manages Internet protocol (IP) addresses.

Control plane 442 is similar to control plane 42 described above except that control plane 442 is specifically illustrated as comprising layers corresponding to those layers of data plane 440. Control plane 442 comprises layer 1, layer 2 and layer 3 corresponding to layer 1, layer 2 and layer 3, respectively, of data plane 440. Layer 1 which programs and control the operations of layer 1 of data plane 440. Layer 2 programs and controls the operations of layer 2 of data plane 440. Layer 3 programs and controls the operations of layer 3 of data plane 440.

As further shown by FIG. 5, each of layers 1, 2 and 3 of data plane 440 comprises associated link failover logic 448, 449 and 450, respectively. Likewise, each of layers 1, 2 and 3 of control plane 442 comprises updating logic 454, 455 and 456, respectively. The failover logic 44A, 449450 each identify the occurrence of a downed link, such as link 32. The updating logic 454, 455 and 456 each receive notifications from the failover logic of the corresponding layer of data plane 440 of the downlink and proceed with updating of forwarding table 46 independent of the updating of centralized database 52. In the example illustrated, switch 420 may update forwarding table 46 independent of centralized database routing table 52 in any of three different states or modes using selected pairs of link failover logic and updating logic. In other implementations, switch 420 may omit some of the different modes or avenues for independently updating forwarding table 46.

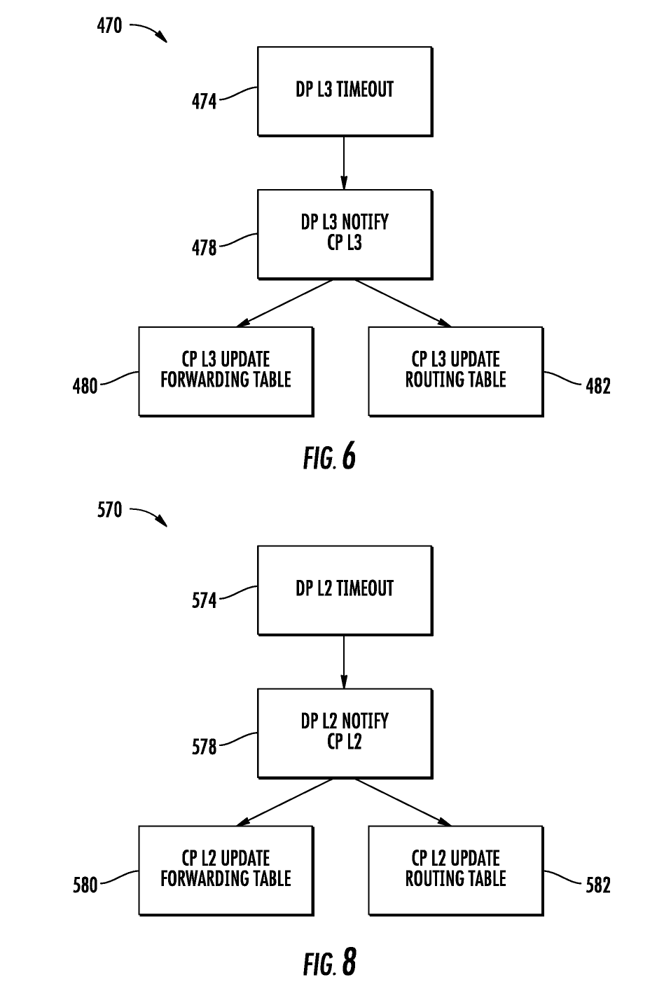

FIGS. 5 and 6 illustrate the updating of forwarding table 46 using link failover logic 448 and updating logic 454. FIG. 6 is a flow diagram of an example method 470 illustrating response of switch 420 to a downed link. As indicated by block 474, failover logic 448 operates in layer 3 of data plane 440 to identify a failed or “downed” link, such as link 32. In one implementation, a failed link is identified by completion of a timeout, wherein a layer 3 timeout refers to a lack of a response from a destination across a link during a predefined amount of time. As indicated by block 478, upon identifying a failed link, layer 3 of data plane 440 notifies layer 3 of the control plane 442. As indicated by block 480, upon receiving notification of the failed link, updating logic 454 updates forwarding table 46 in layer 3 of data plane 440. As indicated by block 482, layer 3 of control plane 442 additionally initiates the updating of centralized database routing table 52. The updating of routing table 52 is independent of the updating of forwarding table 46. In other words, the updating of forwarding table 46 to remove or reflect the downed or failed link is not dependent upon routing table 52 being updated to remove or reflect the downed or failed link.

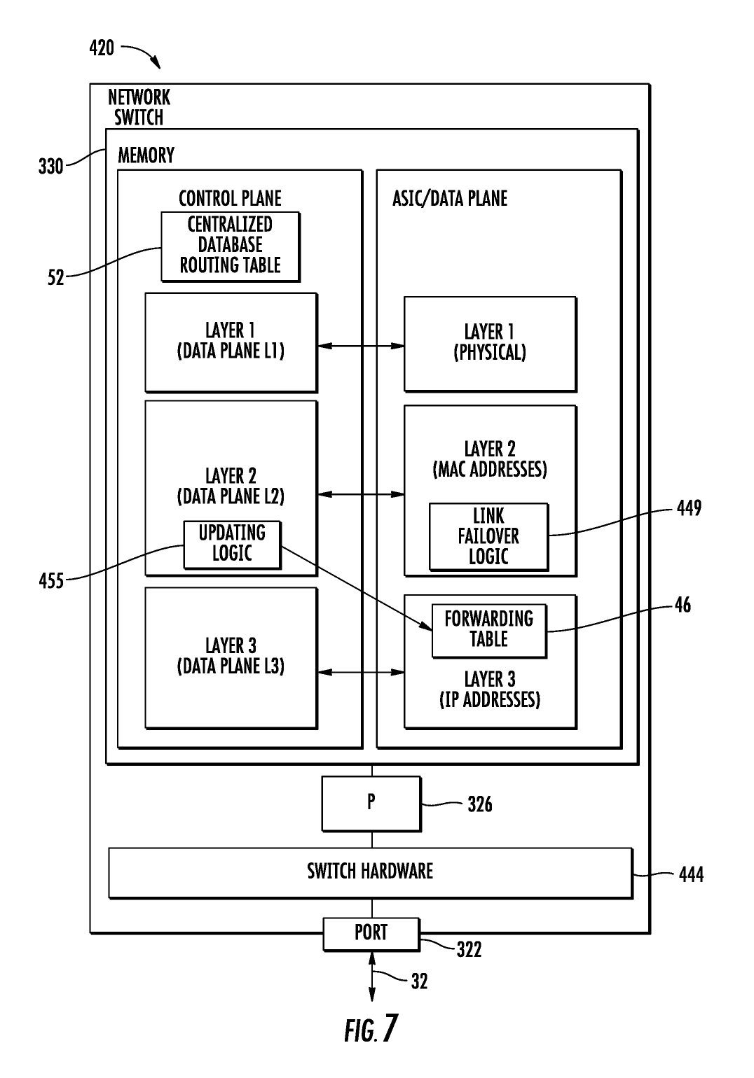

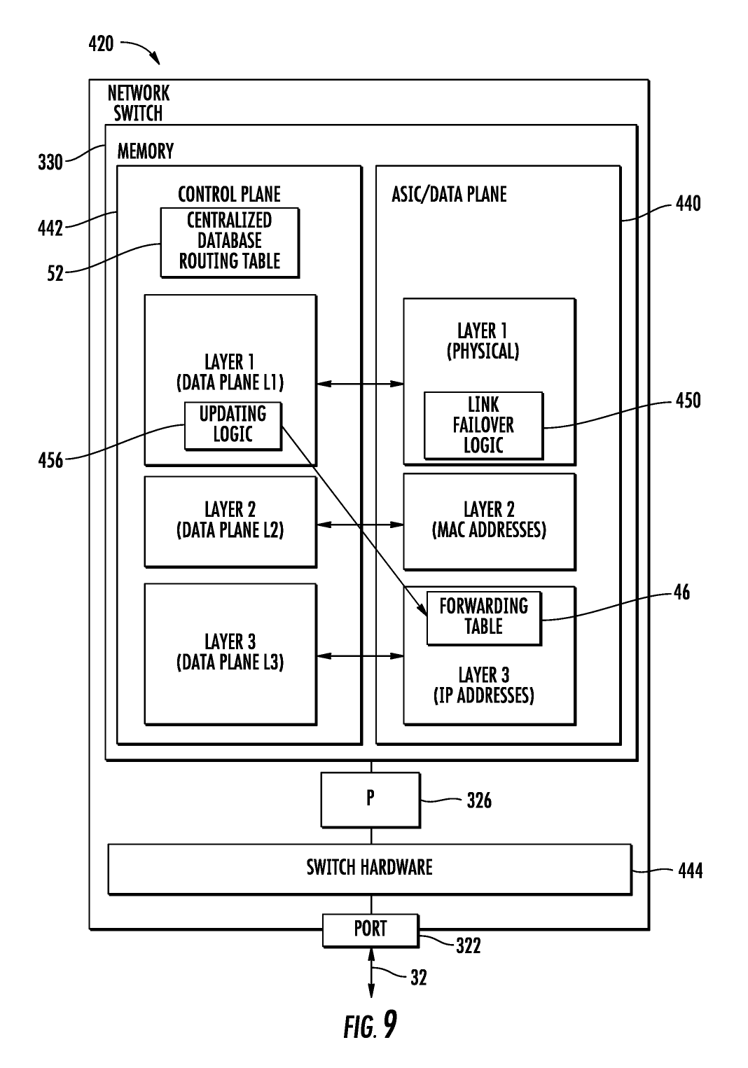

FIGS. 7 and 8 illustrate the updating of forwarding table 46 using link failover logic 449 and updating logic 454. For ease of illustration, the link failover logic and updating logic not being utilized are omitted from FIG. 7. FIG. 8 is a flow diagram of an example method 570 illustrating response of switch 420 to a downed link. In some implementations, method 570 may facilitate faster updating of forwarding table 46 as compared to method for 70 described above. As indicated by block 574, failover logic 449 operates in layer 2 of data plane 440 to identify a failed or “downed” link, such as link 32. In one implementation, a failed link is identified by completion of a timeout, wherein a layer 2 timeout refers to a lack of a response from a destination across a link during a predefined amount of time. As indicated by block 578, upon identifying a failed link, layer 2 of data plane 440 notifies layer 2 of the control plane 442. As indicated by block 580, upon receiving notification of the failed link, updating logic 455 updates forwarding table 46 in layer 3 of data plane 440. In one implementation, layer 2 of control plane 442 causes layer 3 of control plane 442 to update forwarding table 46 of data plane 440. As indicated by block 582, layer 2 of control plane 442 additionally initiates the updating of centralized database routing table 52. The updating of routing table 52 is independent of the updating of forwarding table 46. In other words, the updating of forwarding table 46 to remove or reflect the downed or failed link is not dependent upon routing table 52 being updated to remove or reflect the downed or failed link.

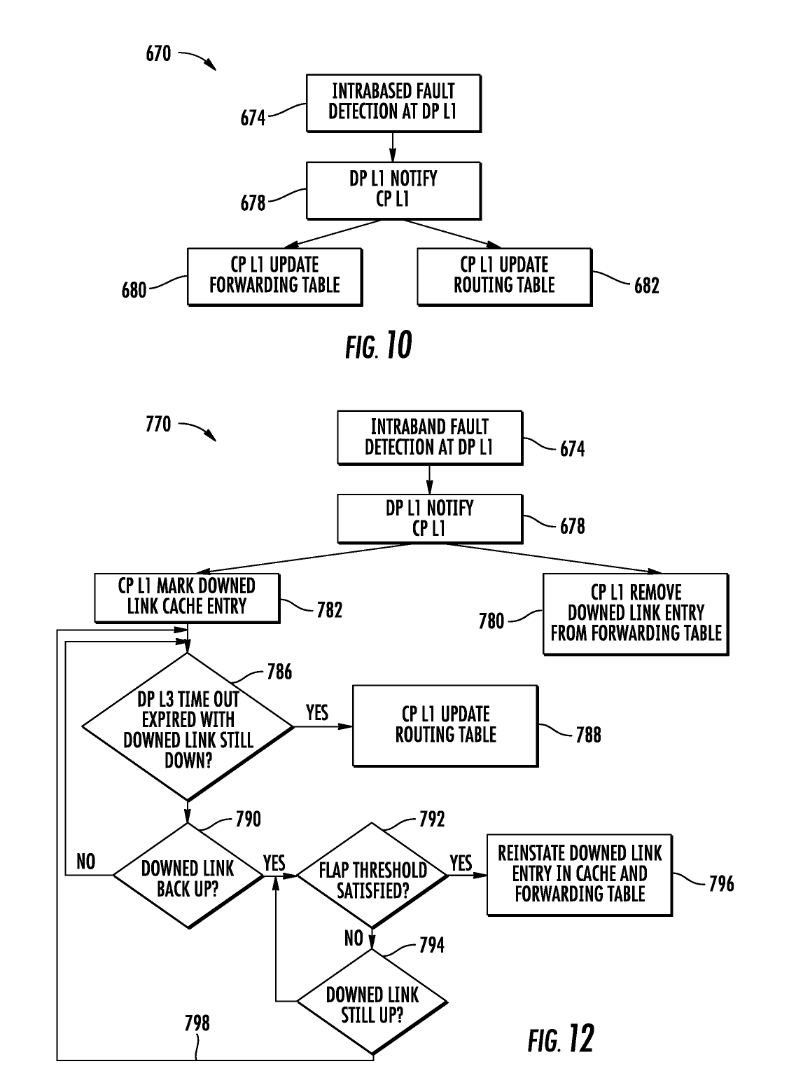

FIGS. 9 and 10 illustrate the updating of forwarding table 46 using link failover logic 450 and updating logic 456. For ease of illustration, the link failover logic and updating logic not being utilized are omitted from FIG. 9. FIG. 10 is a flow diagram of an example method 670 illustrating response of switch 420 to a downed link. In some implementations, method 670 may facilitate faster updating of forwarding table 46 as compared to method 570 described above. As indicated by block 674, failover logic 450 operates in layer 1 of data plane 440 to identify a failed or “downed” link, such as link 32. In one implementation, the link failover logic 450 may comprise an intra-band fault detection module that detects link failures in response to receiving signals from downstream hardware indicating a failed link or in response to polling of the downstream link. In one implementation, the intraband fault detection module serving as the link failover logic may comprise a link scan module.

As indicated by block 678, upon identifying a failed link, the intraband fault detection module of layer 1 of data plane 440 notifies layer 1 of the control plane 442. As indicated by block 680, upon receiving notification of the failed link, updating logic 456 updates forwarding table 46 in layer 3 of data plane 440. In one implementation, layer 1 of control plane 442 causes layer 3 of control plane 442 to update forwarding table 46 of data plane 440. As indicated by block 682, layer 1 of control plane 442 additionally initiates the updating of centralized database routing table 52. The updating of routing table 52 is independent of the updating of forwarding table 46. In other words, the updating of forwarding table 46 to remove or reflect the downed or failed link is not dependent upon routing table 52 being updated to remove or reflect the downed or failed link.

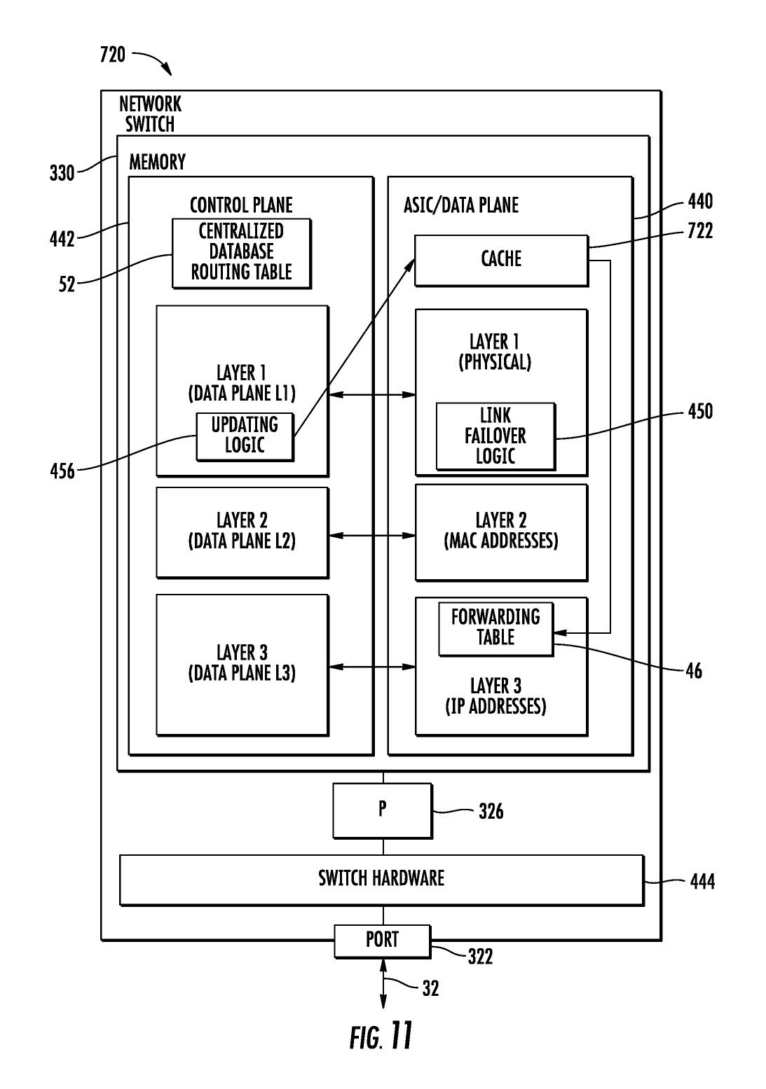

FIG. 11 is a block diagram schematically illustrating portions of an example network switch 720 for use in his centralized database network routing system. Network switch 720 is similar to network switch 420 except that network switch 720 is illustrated as additionally comprising cache 722. Those remaining components of network switch 720 which correspond to components of network switch 420 are numbered similarly.

FIG. 12 is a flow diagram illustrating an example method 770 for updating the forwarding table 46 of the network switch of FIG. 11. For ease of illustration, the link failover logic and updating logic not being utilized as part of method 770 (link failover logic 448, 449 and updating logic 454, 455) are omitted from FIG. 11. Method 770 accommodates a downed link becoming active or becoming “up” following temporary failure. Method 770 further employs link up dampener logic such that when a link is toggling up and down (between an operating and inoperative state, response to a new “up” state is slow while response to a “downed” state is fast.

As in method 670 and indicated by block 674, failover logic 450 operates in layer 1 of data plane 440 to identify a failed or “downed” link, such as link 32. In one implementation, the link failover logic 450 may comprise an intra-band fault detection module that detects link failures in response to receiving signals from downstream hardware indicating a failed link or in response to polling of the downstream link. In one implementation, the intraband fault detection module serving as the link failover logic may comprise a link scan module. As indicated by block 678, upon identifying a failed link, the intraband fault detection module of layer 1 of data plane 440 notifies layer 1 of the control plane 442.

As indicated by block 780, upon receiving notification of the failed link, updating logic 456 updates forwarding table 46 in layer 3 of data plane 440. In one implementation, layer 1 of control plane 442 causes layer 3 of control plane 442 to update forwarding table 46 of data plane 440. In the example illustrated, layer one of control plane the downed link entry from forwarding table 46. As indicated by block 782, layer 1 of control plane 442 marks the downed link entry in a cache that corresponds to the forwarding table. In one implementation, the entry in the cache corresponding to the downed link is labeled as “invalid”. This marking is a temporary indicator of the current state of the link.

As indicated by block 786, layer 3 of data plane 440 determines whether layer 3 of data plane 440 has experienced a timeout, the timeout has expired with respect to the downed link. For example, a determination made as to whether layer 3 of data plane 440 has experienced a lack of a response from a destination across a link during a predefined amount of time. Such a lack of response and the layer 3 of data plane 440 experiencing a timeout may confirm the failed state of the link. As indicated by block 788, upon layer 3 of data plane 440 experiencing a timeout with respect to the downed link, layer 1 of control plane 442 initiates updating of routing table 52 to reflect the downed link. The updated routing table 52, reflecting the downed link will subsequently impact routing path decisions made by control plane 442 in accordance with the routing protocol.

As indicated by block 790, the layer of data plane 440 that determined that the link was down determines whether the link is back up, such as by receiving a response across the downed link or receiving a signal from across a link indicating the link is now active or up. As indicated by block 792, if the previously downed link is back up, a determination is made as to whether a flap threshold has been satisfied. The flap threshold is a predetermined amount of time for the previously downed link which is now indicated as being up to be in a continuous state of being up or running. As indicated by block 794, if the flap threshold has not yet been satisfied, the upper active link is monitored until the flap threshold has been satisfied. As indicated by block 796, once the flap threshold has been satisfied, layer 1 of the control plane 442 reinstates the downed link entry in cache 722. This subsequently results in the entry for the downed link also being reinstated in forwarding table 46. As indicated by line 798, should the link go down again prior to completion of the flap threshold, the process returns to block 786, awaiting completion of the data plane layer 3 timeout such that the centralized database routing table 52 may be updated with the downed link.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A switch in a network, the switch comprising:
a storage device configured to store a forwarding table and a routing table;
a failover module configured to identify failure information associated with a failed link in a transmission path of the network; and
an updating module configured to:
update the forwarding table based upon the failure information independent of updating of the routing table;
determine whether the failed link has recovered within a threshold time; and
in response to determining that the failed link has not recovered within the threshold time, update the routing table based upon the failure information.

2. The switch of claim 1, further comprising:
at least one processing unit and a memory device, wherein the memory device comprises:
instructions for the failover module and the updating module.

3. The switch of claim 1, wherein the failure information comprises one or more of:
information of physical aspects of the switch;
information of media access control (MAC) aspects of the switch; and
information of internet protocol aspects of the switch.

4. (canceled)

5. The switch of claim 1, further comprising a fault detection module configured to detect a failure associated with the failed link.

6. (canceled)

7. (canceled)

8. The switch of claim 1, wherein the forwarding table includes one or more of: layer-2 forwarding information and layer-3 forwarding information.

9. The switch of claim 1, further comprising a cache associated with the forwarding table;
wherein updating the forwarding table comprises:
removing an entry for the failed link from the forwarding table; and
maintaining an entry for the failed link in the cache until completion of the updating of the routing table.

10. The switch of claim 1, further comprising a cache associated with the forwarding table;
wherein updating the forwarding table comprises:
removing an entry for the failed link from the forwarding table; and
maintaining an entry for the failed link in the cache until completion of a routing protocol timeout.

11. The switch of claim 1, further comprising recovery module configured to:
identify that the failed link has been recovered; and
reinstate an entry for the failed link in the forwarding table based upon the recovery.

12. A method comprising:
storing a forwarding table and a routing table associated with a switch in a network;
identifying failure information associated with a failed link in a transmission path of the network;
updating the routing table based upon the failure information independent of updating the routing table;
determining whether the failed link has recovered within a threshold time; and
in response to determining that the failed link has not recovered within the threshold time, updating of the routing table based upon the failure information.

13. The method of claim 12, wherein the failure information comprises one or more of: information of physical aspects of the switch, information of media access control (MAC) aspects of the switch, and information of internet protocol address aspects of the switch.

14. (canceled)

15. (canceled)

16. The method of claim 12, wherein the forwarding table includes one or more of: layer-2 forwarding information and layer-3 forwarding information.

17. The method of claim 12, wherein updating the forwarding table comprises:
removing an entry for the failed link from the forwarding table; and
maintaining an entry for the failed link in a cache associated with the forwarding table until completion of the updating of the routing table.

18. The method of claim 12, wherein updating the forwarding table comprises:
removing an entry for the failed link from the forwarding table; and
maintaining an entry for the failed link in a cache associated with the forwarding table until completion of a routing protocol timeout.

19. The method of claim 12, further comprising:
identifying that the failed link has been recovered; and
reinstating an entry for the failed link in the forwarding table based upon the recovery.

20. A non-transitory computer-readable storage medium storing instructions that when executed by a processing unit cause the processing unit to perform a method, the method comprising:
storing a forwarding table and a routing table associated with a switch in a network;
identifying failure information associated with a failed link in a transmission path of a network;
updating the forwarding table based upon the failure information independent of updating the routing table;
determining whether the failed link has recovered within a threshold time; and
in response to determining that the failed link has not recovered within the threshold time, updating the routing table based upon the failure information.

21. The non-transitory computer-readable storage medium of claim 20, wherein the failure information comprises one or more of: information of physical aspects of the switch, information of media access control (MAC) aspects of the switch, and information of internet protocol address aspects of the switch.

22. The method of claim 12, further comprising detecting a failure associated with the failed link.

23. The non-transitory computer-readable storage medium of claim 20, wherein the forwarding table includes one or more of: layer-2 forwarding information and layer-3 forwarding information.

24. The non-transitory computer-readable storage medium of claim 20, wherein updating the forwarding table comprises:
removing an entry for the failed link from the forwarding table; and
maintaining an entry for the failed link in a cache associated with the forwarding table until completion of the updating of the routing table.

25. The non-transitory computer-readable storage medium of claim 20, wherein updating the forwarding table comprises:
removing an entry for the failed link from the forwarding table; and
maintaining an entry for the failed link in a cache associated with the forwarding table until completion of a routing protocol timeout.

26. The non-transitory computer-readable storage medium of claim 20, wherein the method further comprises:
identifying that the failed link has been recovered; and
reinstating an entry for the failed link in the forwarding table based upon the recovery.
